(19) United States
(12) Patent Application Publication
(10) Pub. No.: US 2022/0257471 A1
(43) Pub. Date: Aug. 18, 2022

(54) DRUG ACCOMMODATING DEVICE OF SOLID ORAL FORMULATION, AND ORAL ADMINISTRATION AND DELIVERY APPARATUS COMPRISING SAME

(71) Applicant: SHANGHAI WD PHARMACEUTICAL CO., LTD, Shanghai (CN)

(72) Inventors: Liang Chang DONG, Shanghai (CN); Yang LEI, Shanghai (CN); Gang WU, Shanghai (CN); Shizhong ZHANG, Shanghai (CN); Jingmin SHI, Shanghai (CN); Xishan CHEN, Shanghai (CN)

(21) Appl. No.: 17/625,260

(22) PCT Filed: Mar. 12, 2020
(86) PCT No.: PCT/CN2020/079017

§ 371 Date: Jan. 6, 2022

(30) Foreign Application Priority Data
Sep. 30, 2019 (CN) 201910939687.8
Sep. 30, 2019 (CN) 201921652286.6

(51) Int. Cl. A61J 7/00

(52) U.S. Cl. CPC A61J 7/0038

(57) ABSTRACT

A drug accommodating device of a solid oral formulation and an oral administration and delivery apparatus comprising same. The drug accommodating device comprises a filtering component and a supporting component; the filtering component and the supporting component cooperate with each other to form a space used for bearing drug particles or multiple pills; the filtering component has one or more pore channels allowing a liquid to pass; the pore channels are distributed in the filtering component in an up-down intricate intersection mode; alternatively, a water-soluble polymer material layer is provided on the filtering component. Alternatively, the drug accommodating device is a cylindrical structure with a top end being an opening and a bottom part being a screen mesh; the inner surface of the screen mesh is provided with the water-soluble polymer material layer; an inner cavity having the cylindrical structure above water-soluble polymer material layer is used for accommodating the drug particles or multiple pills. The drug accommodating device can overcome the problem that fluid resistance is large when the drug particles or multiple pills are leaked and sipped.

The present application claims the priority of Chinese patent application CN201910939687.8 filed on Sep. 30, 2019 and Chinese patent application CN201921652286.6 filed on Sep. 30, 2019. The present application refers to the full text of the above-mentioned Chinese patent applications.

### TECHNICAL FIELD

The present invention relates to the field of medical devices, in particular to a drug accommodating apparatus of a solid oral formulation and an oral delivery device comprising the same.

### BACKGROUND

Tablets and capsules are the most convenient and easily accepted oral dosage forms. However, some patients, especially children and the elderly, often find it difficult to swallow large-sized tablets and capsules. Some patients are unwilling to take the type of drugs because of the unacceptable taste. Therefore, various drug administration devices have been proposed in the prior art, which can promote swallowing of large-sized tablets and capsules and minimize a patient's perception of the dose and taste. All kinds of drug administration devices involve drug accommodating components which can contain and store drugs, and the following patents and applications related to drug accommodating components of sipping devices are hereby incorporated by reference.

EP 0383503 A1 describes an improved device. A drug holding component of the device is a sieve, the surface area of which is larger than the cross-sectional area of a lumen of a tube, and which is used to hold and position a unit dose of therapeutic agent in the tube; and the device is adapted to delivery of a dose through the tube by a normal sipping action of a patient.

U.S. Pat. No. 6,096,003 describes a sipping device. A drug accommodating component of the device is a stopper, which can be used to contain active pharmaceutical ingredients, and the stopper is driven by a liquid to slide upward in a lumen, thus completing drug delivery.

U.S. Pat. No. 6,109,538 discloses a sipping device. Accommodating components of the device are a pair of screen meshs with rectangular grids, which are arranged in a tube cavity for limiting seasoning objects.

U.S. Pat. No. 6,333,050 B2 describes a sipping device. A drug accommodating component of the device is a one-way valve, which is used for accommodating a drug when it is not a sipping body, and is deformed when it is sipping, allowing a liquid to pass through.

U.S. Pat. No. 8,334,003 B2 describes a sipping device, which comprises an elongated tubular component with a pair of filtering devices at each end of the tubular component, so as to hold flavoring particles in the filtering devices, thereby allowing flavoring agents to enter ordinary beverages by normal suction.

U.S. Pat. No. 6,224,908 B1 describes an active pharmaceutical ingredient delivery device with a fluid controller. The fluid controller is a porous plug, which has little friction with the tube wall, holds a drug in a non-sipping state, and accelerates the delivery of the drug to a patient's mouth under the push of the fluid during sipping.

There are many problems in the practical application of the drug accommodating components mentioned in the above patents. As we all know, the granules or multi-particulates containing active pharmaceutical ingredients prepared by wet granulation, dry granulation, extrusion rolling, melt granulation or the like generally have relatively wide particle size distribution, including drug granules or multi-particulates much larger than an average particle size and fine powder granules or multi-particulates much smaller than the average particle size. Therefore, with regard to a function of the drug accommodating component, on the one hand, it is required that a liquid can smoothly pass through the drug accommodating component with little resistance, so that a patient does not need any effort when sipping; and on the other hand, it is required that the pore diameter of the drug accommodating component is smaller than the diameters of all granules or multi-particulates, so as to ensure that the granules or multi-particulates will not leak through the drug accommodating component. These two demands are in contradiction with each other, namely that the pore diameter is large enough, so that the resistance of liquid passing is small; however, the larger the pore diameter is, the greater the probability of leakage of granules or multi-particulates with smaller particle sizes will be. Therefore, the present application range is limited, and materials accommodating drug comprising granules or multi-particulates with the particle sizes smaller than or equal to the pore diameter of the drug accommodating component cannot use the device unless they are screen meshed artificially, which reduces the yield and increases the cost.

### CONTENT OF THE PRESENT INVENTION

The technical problem to be solved by the present invention is to overcome defects of leakage of drug granules or multi-particulates and large fluid resistance during sipping existing in devices for promoting drug swallowing in the prior art, and to provide a drug accommodating apparatus of a solid oral preparation and an oral delivery device comprising the same. When in use, the drug accommodating apparatus of the present invention is integrated with a straw, and is used for accommodating granules or multi-particulates containing active pharmaceutical ingredients with particle sizes larger than, equal to or smaller than the pore diameter of the drug accommodating apparatus.

At the beginning of research and development, the inventor of the present invention found that reducing liquid resistance and reducing drug leakage are opposite propositions in theory, and it is difficult to strike a balance. Therefore, the technical difficulty of the present invention lies in finding a reasonable solution, which not only ensures low liquid resistance, but also ensures that loaded granules or multi-particulates do not leak.

As for the mechanism, there are two mechanisms for allowing the drug granules or multi-particulates with the particle sizes smaller than or equal to the pore diameter of a filtering component: one is to intercept the fine particles in the filtering component through irregular staggered pore channels in the filtering component, which requires a certain thickness, for example, the thickness is more than 0.5 mm; and the other is to form a membrane on the filtering component through a water-soluble polymer material, and block pores of the filtering component. During sipping, the polymer material dissolves instantly, and water flows through, driving a drug into a patient's mouth. The mechanism has no requirement on the thickness of the filtering component.

One of the purposes of the present invention is to provide a drug accommodating apparatus of a solid oral preparation, which comprises a filtering component and a supporting component for supporting the filtering component, wherein the filtering component and the supporting components cooperate with each other to form space for bearing drug granules or multi-particulates, and the filtering component has one or more pore channels allowing a liquid to pass; and when the thickness of the filtering component is more than 0.5 mm, the pore channels are distributed in the filtering component in an up-down intricate intersection mode, so that the drug granules or multi-particulates cannot pass through.

Next, the manner in which the pore channels of the filtering component are arranged in a vertically and intricately crossed structure will be specifically described.

In the present invention, the filtering component is a common type in the art, preferably a filter membrane. The shape of the filter membrane is preferably a cylindrical structure. The thickness of the filter membrane is preferably 0.5-20 mm, more preferably 0.5-15 mm, and further more preferably 0.5-10 mm, such as 2 mm.

In other words, the filter membrane has a certain thickness, so the pore channels of the filter membrane are arranged in a vertically and intricately crossed structure, preferably that the upper and lower surfaces and the inner pore channels of the filter membrane are arranged in an irregular and intricately crossed structure, such as a spongy porous structure or a fluffy structure formed by irregularly stacking and pressing multiple layers of fibers. In the way, even if particle sizes of the drug granules or multi-particulates are smaller than or equal to the pore diameter of the filter membrane, the drug granules or multi-particulates will not directly pass through the drug accommodating apparatus like passing through a screen mesh. Because of the zigzag and intricate crossing of the pore channels of the filter membrane, the drug granules or multi-particulates with very small particle sizes will accumulate on the surface and inside. When a liquid passes through, the drug granules or multi-particulates accumulated on the surface and inside of the filter membrane are delivered into the patient's mouth.

Next, a material, a pore diameter and setting conditions of a preparation process of the filtering component (such as the filter membrane) will be specifically described:

The filter membrane is made of a conventional filter membrane material in the art, including but not limited to one or more of the following materials: polypropylene, polyethylene, polyvinyl chloride, polyvinylidene chloride, polyethylene terephthalate, cellulose acetate, polylactic acid, polyglycolic acid, polylactic acid-glycolic acid copolymer, glass fiber, nylon, polyether sulfone, polyvinylidene fluoride and polytetrafluoroethylene.

The shape of the raw material of the filter membrane is conventional in the art, including but not limited to granular, flaky, fibrous, etc.

The pore diameter of the filter membrane is conventional in the art, such as 1-500 μm, preferably 20-400 μm, more preferably 40-300 μm, such as 150 μm, 200 μm, 250 μm and 300 μm.

The diameter of the filter membrane can be conventional in the art, and the diameter of the filter membrane is defined as the effective diameter for trapping solids and passing liquids. In view of design and installation process, if the outermost ring of the filter membrane diameter is pressed in the middle by upper and lower supporting components for fixing the filter membrane, for example, a membrane with a diameter of 10 mm, the edge of which is for 1 mm pressed by the supporting components, and the effective diameter is only 8 mm. Generally, the effective diameter range of the filter membrane is 4-20 mm, preferably 6-15 mm, more preferably 8 mm-12 mm, such as 10 mm.

The preparation process of the filter membrane is a conventional process in the art, including but not limited to sintering, injection molding, pressing, weaving, etc.

Next, the structure of the supporting component will be specifically described.

In the present invention, the supporting component has a conventional meaning in the art, and a function thereof is to support the filtering component without affecting the filterability and liquid permeability of the filtering component. The structure is preferably as follows: the supporting component is arranged on upper and lower surfaces of the filtering component and clamps the filtering component in the middle, that is, the supporting component clamps the filtering component in the middle like a sandwich form; or the filtering component is wrapped inside in a cage structure.

In a preferable embodiment of the present application, the supporting component comprises an upper supporting component and a lower supporting component, which can be closed with each other and hold the filtering component in the middle, and the space above the upper supporting component and the filtering component is used for accommodating drug granules or multi-particulates. The structure is similar to the sandwich form.

In another preferable embodiment of the present application, the supporting component comprises a filter-component accommodating component and a drug accommodating component, both of which have a pore-like structure end and an open end, wherein the pore-like structure end has one or more holes allowing a liquid to pass through, and the open end of the filter-component accommodating component and the pore-like structure end of the drug accommodating component can be closed to form a cavity for accommodating the filtering component; and the open end of the drug accommodating component is an open tubular structure for accommodating drug granules or multi-particulates. It should be understood by those skilled in the art that the actual function of the filtering component accommodating component in the implementation is to form a cavity with the drug accommodating component for accommodating the filtering component, and the structure is similar to the sandwich form. In addition, sizes of the pore-like structures of the drug accommodating component and the filter-component accommodating component do not affect filterability and liquid permeability of the filtering component.

In another preferable embodiment of the present application, the supporting component comprises a cage-like supporting component with an upward opening and an upper cover matched with the cage-like supporting component, wherein the upper cover is provided with a pore channel for drug granules or multi-particulates and a liquid to circulate, and the cage-like supporting component and the upper cover can enclose to form hollow space and limit the filtering component in the space, and the space above the upper cover and the filtering component is used for accommodating the drug granules or multi-particulates. The structure is similar to the cage structure.

The material of the supporting component is conventional in the art, including but not limited to one or more of the following materials: polypropylene, polyethylene, polyvinyl chloride, polyvinylidene chloride, polyvinylidene fluoride, polytetrafluoroethylene, polyethylene terephthalate, polylactic acid, polyglycolic acid, polylactic acid-glycolic acid copolymer, ceramics, silicon dioxide and organosilicone.

The preparation process of the supporting component is conventional in the art, including but not limited to sintering, injection molding, etc.

Next, forms and types of drug granules or multi-particulates will be specifically described:

In the present invention, the drug granules or multi-particulates have the conventional meaning in the art, and generally refer to granules, powders or multi-particulates containing active pharmaceutical ingredients.

Particle sizes of the drug granules or multi-particulates are conventional in the art, and are generally 1-5000 μm, preferably 25-2000 μm, and more preferably 50-1000 μm.

Preferably, when the particle sizes of the drug granules or multi-particulates are in the range of 50-1000 μm, the pore diameter of the filtering component is 40-300 μm.

The active pharmaceutical ingredients contained in the drug granules or multi-particulates are conventional in the art, including but not limited to one or more of dabigatran etexilate or pharmaceutically acceptable salts thereof (such as dabigatran etexilate mesylate), apixaban, rivaroxaban, levodopa-carbidopa, montelukast, lansoprazole, omeprazole, esomeprazole, amoxicillin, clarithromycin, azithromycin, metronidazole, rifampicin, sulfasalazine, acetaminophen, dextromethorphan, doxylamine, pseudo ephedrine, diphenhydramine, amphetamine, methylphenidate, deferasirox, ivacaftor, lumacaftor, tacrolimus, diazepam, clobazam, vigabatrin, bosentan, melatonin, biotin, sodium dimercaptosuccinate, amlodipine and esmolol.

The preparation process of the drug granules or multi-particulates comprises but is not limited to one or more of the following processes: wet granulation, dry granulation, extrusion rolling, melt granulation, ion exchange resin granulation, and pellet spraying applying.

The second purpose of the present invention is to provide an oral delivery device, which comprises the drug accommodating apparatus described in the first purpose. The oral delivery device further comprises a tubular component with two end openings and an inner cavity, wherein one end opening is a first opening and the other end opening is a second opening, and the inner cavity is communicated with the first opening and the second opening; and the drug accommodating apparatus is externally connected to a free end of the first opening, and makes space for bearing drug granules or multi-particulates communicated with the inner cavity.

Next, the manner in which the drug accommodating apparatus is arranged outside the free end of the first opening will be specifically described.

In the present embodiment, preferably, the drug accommodating apparatus is placed outside the tubular component, and is maintained at the first opening of the tubular component by a fixed sleeve or threaded connection.

In the present embodiment, granules or multi-particulates containing active pharmaceutical ingredients are placed in the cavity of the drug accommodating apparatus. When in use, one end of the supporting component contacts with a liquid, and the liquid is sucked into the tubular component through the filtering component by sipping. The granules or multi-particulates containing the active pharmaceutical ingredients enter the tubular component with the liquid and then enter a mouth.

In the present embodiment, preferably, the second opening is also provided with a top cover for sealing, so as to ensure that even if the oral delivery device is bumped or completely inverted during transportation, the drug granules or multi-particulates will not leak from the second opening. Furthermore, an independent outer package can be used to seal the drug-loaded oral delivery device, and then the device can be directly stored or transported, thus a waterproof and moisture-proof role is played.

Next, the structure of the tubular component will be specifically described.

In a preferable embodiment of the present application, the tubular component is a straight straw. The straight straw is preferably provided with at least one fold structure. Preferably, the fold structure has a pair of wings and a turning end; and the fold structure can be stretched or contracted along the axial direction of the tubular component, and a turbulent flow is formed during stretching.

In another preferable embodiment of the present application, the tubular component has at least two tube sections which are hermetically connected and can be axially stretched or contracted along the tubular component; and when the tubular component is in a stretched state, a turbulent flow generating part with at least one step structure is formed.

When the number of the tube sections is 3, the inner diameters of the first tube section and the third tube section in the direction from the first opening to the second opening are the same, the outer diameter of the second tube section is smaller than the inner diameters of the first tube section, and each tube section can be axially stretched or contracted along other tube sections; or, the inner diameter of the first tube section, the outer diameter and the inner diameter of the second tube section, the outer diameter of the third tube section in the direction from the first opening to the second opening are gradually reduced, and each tube section can be axially stretched or contracted along other tube sections.

When the number of the tube sections is 4, the inner diameters of the first tube section and the third tube section in the direction from the first opening to the second opening are the same, and the inner diameters of the second tube section and the fourth tube section are the same, wherein the inner diameter of the second tube section is smaller than that of the first tube section, and each tube section can be axially stretched or contracted along other tube sections; or, the inner diameter thereof gradually decreases from the first tube section to the fourth tube section in the direction from the first opening to the second opening, and each tube section can be axially stretched or contracted along other tube sections.

The third purpose of the present invention is to provide an oral delivery device, which comprises the drug accommodating apparatus described in the first purpose. The oral delivery device further comprises a tubular component with two end openings and an inner cavity, wherein one end opening is a first opening and the other end opening is a second opening, and the inner cavity is communicated with the first opening and the second opening; the drug accommodating apparatus is arranged in the inner cavity and close to the first opening, and space for bearing drug granules or multi-particulates is communicated with the second opening; and the diameter of the first opening is smaller than the minimum diameter of the drug accommodating apparatus.

In the present embodiment, by specifying the diameter of the first opening to be smaller than the minimum diameter of the drug accommodating apparatus, the drug accommodating apparatus can be maintained in the inner cavity in any way without falling off from the first opening of the tubular component.

In the present embodiment, preferably, the diameter of the second opening is smaller than the minimum diameter of the drug accommodating apparatus.

In the present embodiment, preferably, the second opening is also provided with a top cover for sealing, so as to ensure that even if the oral delivery device is bumped or completely inverted during transportation, the drug granules or multi-particulates will not leak from the second opening.

In the present embodiment, the specific description of the structure of the tubular component is the same as that described in the second purpose.

The fourth purpose of the present invention is to provide a drug accommodating apparatus of a solid oral preparation, which has a structure 1 or a structure 2:

Structure 1: The drug accommodating apparatus comprises a filtering component and a supporting component for supporting the filtering component, wherein the filtering component and the supporting components cooperate with each other to form space for bearing drug granules or multi-particulates, and the filtering component has one or more pore channels allowing a liquid to pass; and the filtering component is also provided with a water-soluble polymer material layer, so that the drug granules or multi-particulates cannot pass through; and

Structure 2: The drug accommodating apparatus is a cylindrical structure with a top end being an opening and a bottom part being a screen mesh, and the inner surface of the screen mesh is provided with a water-soluble polymer material layer, and the inner cavity having the cylindrical structure above the water-soluble polymer material layer is used for accommodating drug granules or multi-particulates.

The present embodiment has a wide application range, and is especially suitable for the situation that part of the particle sizes in particle size distribution of the drug granules or multi-particulates are smaller than or equal to the pore diameter of the pore channel.

Next, a structure, a material, a pore diameter and setting conditions of a preparation process of the filtering component in structure 1 will be specifically described:

In the present invention, the filtering component is a conventional type in the art, and is preferably a filter membrane. The filter membrane is preferably a wafer structure. The thickness of the filter membrane is preferably 0.01-0.5 mm, more preferably 0.1-0.3 mm, such as 0.2 mm. In the case, because the thickness of the filter membrane is thin and a function thereof is similar to that of a screen mesh, when the resistance of liquid passing through the screen mesh is very small, drug granules or multi-particulates with particle sizes smaller than or equal to the pore diameter of the filter membrane will leak out from the filtering component, so that a water-soluble polymer material layer is arranged on the filter membrane.

Wherein, the filter membrane is made of conventional filter membrane materials in the art, including but not limited to one or more of the following materials: polypropylene, polyethylene, polyvinyl chloride, polyvinylidene chloride, polyethylene terephthalate, cellulose acetate, polylactic acid, polyglycolic acid, polylactic acid-glycolic acid copolymer, glass fiber, nylon, polyether sulfone, polyvinylidene fluoride and polytetrafluoroethylene. The shape of the raw material of the filter membrane includes but is not limited to granular, flaky, fibrous and the like.

Wherein, the shape and structure of the pore channel in the filter membrane can be the conventional regular structure in the art, for example, connecting and penetrating the upper and lower surfaces of the filter membrane in a straight line way.

Wherein, the pore diameter of the filter membrane is conventional in the art, such as 1-500 μm, preferably 20-400 μm, more preferably 40-300 μm, such as 150 μm, 200 μm, 250 μm and 300 μm.

Wherein, the diameter of the filter membrane can be conventional in the art, and the diameter of the filter membrane is defined as the effective diameter for trapping solids and passing through liquids. In view of design and installation process, the outermost ring of the filter membrane diameter will be pressed between the upper and lower supporting components for fixing the filter membrane, for example, a membrane with a diameter of 10 mm, the edge of which is for 1 mm pressed by the supporting components, and the effective diameter is only 8 mm. Generally, the effective diameter range of the filter membrane is 4-20 mm, preferably 6-15 mm, more preferably 8 mm-12 mm, such as 10 mm.

Wherein, the preparation process of the filter membrane is a conventional process in the art, including but not limited to sintering, injection molding, pressing, weaving, etc.

Next, the arrangement mode of the water-soluble polymer material layer will be specifically described.

In the present invention, the forming method of the water-soluble polymer material layer is conventional in the art, and preferably: a polymer material solution is adsorbed, coated or sprayed on the upper surface and/or the lower surface of the filter membrane, or the filter membrane is immersed in the polymer material solution and dried. After drying, the polymer material is dispersed in pores and materials of the filter membrane to form a skeleton with a certain hardness, and meanwhile, the pore channels of the filter membrane are blocked, so that drug granules or multi-particulates smaller than or equal to the pore diameter of the filter membrane will not leak during storage and transportation.

Specifically, the water-soluble polymer material layer preferably has the following two structures: a continuous water-soluble polymer material layer is formed on the upper or lower surface of the filter membrane, or the polymer material will completely block the pore channels of the filter membrane and form a complete and compact water-soluble polymer material layer (for example, the structure is formed by dipping), and more preferably, a continuous water-soluble polymer material layer is formed only on the upper or lower surface of the filter membrane (for example, the structure is formed only by adsorption, coating or spraying on a certain surface of the filter membrane), and further more preferably, a continuous water-soluble polymer material layer is formed on the lower surface of the filter membrane.

The dissolution time of the water-soluble polymer material layer is preferably less than or equal to 10 s, such as 2 s. In use, the patient places the drug accommodating apparatus in the liquid and then sips, and meanwhile, the water-soluble polymer material layer dissolves in a very short time, and the liquid passes through the drug accommodating apparatus with very little resistance to deliver the drug granules or multi-particulates into the patient's mouth. Because the water-soluble polymer material layer dissolves quickly, the patient can't feel the change of resistance in use.

In order to make the polymer material better formed on the surface of the filter membrane, the water-soluble polymer material layer is preferably made of a polymer material with good water solubility and a good film forming property and a low molecular weight, and is formed into a polymer material solution and then formed by a certain process.

The molecular weight of the polymer material is preferably 2000-200000, more preferably 2000-100000. The type of the polymer material is preferably selected from one or more of hydroxypropyl methylcellulose, copolyvidone, hydroxypropyl cellulose, hydroxyethyl cellulose (HEC), povidone, polyethylene glycol (PEG), gelatin, poloxamer, xanthan gum and Eudragit.

The preparation method of the polymer material solution is a conventional method in the art, and specifically comprises the following steps: uniformly mixing a polymer material and a solvent, wherein the solvent is a conventional solvent which can dissolve polymer materials and is volatile, such as water, ethanol, acetone, etc.

In the forming process of the water-soluble polymer material layer, the viscosity of the polymer material solution is a key parameter in the forming process, and the viscosity depends on three parameters, namely the concentration, molecular weight and chemical structure of a polymer. The viscosity generally ranges from 2 centipoise (cP) to 5000 centipoise (cP), preferably 2 cP-1000 cP. The concentration of the polymer material solution is preferably 0.1%-30%, such as 10%, and the concentration is the mass percentage concentration. In the forming process of the water-soluble polymer material layer, the weight gain of the polymer material is generally 0.01-60 mg/cm², preferably 0.5-30 mg/cm², such as 6.4 mg/cm². Specifically, the meaning of “weight gain of polymer material” is the weight of the water-soluble polymer material layer formed on each square centimeter of the filtering component (such as filter membrane) or screen mesh after curing and drying, and the weight unit is in milligram.

In a preferable embodiment of the present application, the polymer material solution is a hydroxypropyl methylcellulose E3 solution with a concentration of 10%.

Next, the structure of the supporting component in structure 1 will be specifically described.

In the present invention, the supporting component has a conventional meaning in the art, and the function thereof is to support the filtering component without affecting the filterability and liquid permeability of the filtering component.

In a preferable embodiment of the present application, the supporting component comprises an upper supporting component and a lower supporting component, which can be closed with each other and hold the filtering component in the middle, and the space above the upper supporting component and the filtering component is used for accommodating drug granules or multi-particulates. The structure is similar to the sandwich form.

In another preferable embodiment of the present application, the supporting component comprises a filter-component accommodating component and a drug accommodating component, both of which have a pore-like structure end and an open end, wherein the pore-like structure end has one or more holes allowing a liquid to pass through, and the open end of the filter-component accommodating component and the pore-like structure end of the drug accommodating component can be closed to form a cavity for accommodating the filtering component; and the open end of the drug accommodating component is an open tubular structure for accommodating drug granules or multi-particulates. It should be understood by those skilled in the art that the actual function of the filtering component accommodating component in the implementation is to form a cavity with the drug accommodating component for accommodating the filtering component, and the structure is similar to the sandwich form. In addition, sizes of the pore-like structures of the drug accommodating component and the filter-component accommodating component do not affect filterability and liquid permeability of the filtering component.

Wherein, the material of the supporting component is conventional in the art, including but not limited to one or more of the following materials: polypropylene, polyethylene, polyvinyl chloride, polyvinylidene chloride, polyvinylidene fluoride, polytetrafluoroethylene, polyethylene terephthalate, polylactic acid, polyglycolic acid, polylactic acid-glycolic acid copolymer, ceramics, silicon dioxide and organosilicone.

Wherein, the preparation process of the supporting component is conventional in the art, including but not limited to sintering, injection molding, etc.

Next, the cylindrical structure in structure 2 will be specifically described.

The material and preparation process of the cylindrical structure are the same as those described in the supporting component.

The size of the screen mesh is conventional in the art, for example, 200 μm.

Next, forms and types of drug granules or multi-particulates will be specifically described:

In the present invention, the drug granules or multi-particulates have the conventional meaning in the art, and generally refer to granules, powders or multi-particulates containing active pharmaceutical ingredients.

Particle sizes of the drug granules or multi-particulates are conventional in the art, and are generally 1-5000 μm, preferably 25-2000 μm, and more preferably 50-1000 μm.

Preferably, when the particle sizes of the drug granules or multi-particulates are in the range of 50-1000 μm, the pore diameter of the filtering component in the structure 1 or the screen mesh in the structure 2 is 40-300 μm.

Wherein, the active pharmaceutical ingredients contained in the drug granules or multi-particulates are conventional in the art, including but not limited to one or more of dabigatran etexilate or pharmaceutically acceptable salts thereof (such as dabigatran etexilate mesylate), apixaban, rivaroxaban, levodopa-carbidopa, montelukast, lansoprazole, omeprazole, esomeprazole, amoxicillin, clarithromycin, azithromycin, metronidazole, rifampicin, sulfasalazine, acetaminophen, dextromethorphan, doxylamine, pseudo ephedrine, diphenhydramine, amphetamine, methylphenidate, deferasirox, ivacaftor, lumacaftor, tacrolimus, diazepam, clobazam, vigabatrin, bosentan, melatonin, biotin, sodium dimercaptosuccinate, amlodipine and esmolol.

Wherein, the preparation process of the drug granules or multi-particulates comprises but is not limited to one or more of the following processes: wet granulation, dry granulation, extrusion rolling, melt granulation, ion exchange resin granulation, and pellet spraying applying.

The fifth purpose of the present invention is to provide an oral delivery device, which comprises the drug accommodating apparatus described in the fourth purpose. The oral delivery device further comprises a tubular component with two end openings and an inner cavity, wherein one end opening is a first opening and the other end opening is a second opening, and the inner cavity is communicated with the first opening and the second opening; and the drug accommodating apparatus is externally connected to a free end of the first opening, and makes space for bearing drug granules or multi-particulates communicated with the inner cavity.

Next, the manner in which the drug accommodating apparatus is externally arranged at the free end of the first opening will be specifically described.

In the present invention, the drug accommodating apparatus is placed outside the tubular component, and is preferably maintained at the first opening of the tubular component by a fixed sleeve or threaded connection.

In the present embodiment, granules or multi-particulates containing active pharmaceutical ingredients are placed in the cavity of the drug accommodating apparatus. When in use, one end of the supporting component contacts with a liquid, and the liquid is sucked into the tubular component through the filtering component by sipping. The granules or multi-particulates containing the active pharmaceutical ingredients enter the tubular component with the liquid and then enter a mouth.

In the present invention, preferably, the second opening is also provided with a top cover for sealing, so as to ensure that even if the oral delivery device is bumped or completely inverted during transportation, the drug granules or multi-particulates will not leak from the second opening.

Next, the structure of the tubular component will be specifically described.

In a preferable embodiment of the present application, the tubular component is a straight straw. The straight straw is preferably provided with at least one fold structure. Preferably, the fold structure has a pair of wings and a turning end; and the fold structure can be stretched or contracted along the axial direction of the tubular component, and a turbulent flow is formed during stretching.

In another preferable embodiment of the present application, the tubular component has at least two tube sections which are hermetically connected and can be axially stretched or contracted along the tubular component; and when the tubular component is in a stretched state, a turbulent flow generating part with at least one step structure is formed.

When the number of the tube sections is 3, the inner diameters of the first tube section and the third tube section in the direction from the first opening to the second opening are the same, the outer diameter of the second tube section is smaller than the inner diameter of the first tube section, and each tube section can be axially stretched or contracted along other tube sections; or, the inner diameter of the first tube section, the outer diameter and the inner diameter of the second tube section, the outer diameter of the third tube section in the direction from the first opening to the second opening are gradually reduced, and each tube section can be axially stretched or contracted along other tube sections.

When the number of the tube sections is 4, the inner diameters of the first tube section and the third tube section in the direction from the first opening to the second opening are the same, and the inner diameters of the second tube section and the fourth tube section are the same, wherein the inner diameter of the second tube section is smaller than that of the first tube section, and each tube section can be axially stretched or contracted along other tube sections; or, the inner diameter thereof gradually decreases from the first tube section to the fourth tube section in the direction from the first opening to the second opening, and each tube section can be axially stretched or contracted along other tube sections.

The sixth purpose of the present invention is to provide an oral delivery device, which comprises the drug accommodating apparatus described in the fourth purpose. The oral delivery device further comprises a tubular component with two end openings and an inner cavity, wherein one end opening is a first opening and the other end opening is a second opening, and the inner cavity is communicated with the first opening and the second opening; the drug accommodating apparatus is arranged in the inner cavity and close to the first opening, and space for bearing drug granules or multi-particulates is communicated with the second opening; and the diameter of the first opening is smaller than the minimum diameter of the drug accommodating apparatus.

In the present invention, by specifying the diameter of the first opening to be smaller than the minimum diameter of the drug accommodating apparatus, the drug accommodating apparatus can be maintained in the inner cavity in any way without falling off from the first opening of the tubular component.

In the present invention, preferably, the diameter of the second opening is smaller than the minimum diameter of the drug accommodating apparatus.

In the present invention, preferably, the second opening is also provided with a top cover for sealing, so as to ensure that even if the oral delivery device is bumped or completely inverted during transportation, the drug granules or multi-particulates will not leak from the second opening.

In the present invention, the specific description of the structure of the tubular component is the same as that described in the fifth purpose.

The seventh purpose of the present invention is to provide a drug accommodating apparatus of a solid oral preparation, which comprises a filtering component and a supporting component for supporting the filtering component, wherein the filtering component and the supporting components cooperate with each other to form space for bearing drug granules or multi-particulates, and the filtering component has one or more pore channels allowing a liquid to pass; and the pore channels are distributed in the filtering component in an up-down intricate intersection mode, and a water-soluble polymer material layer is also arranged on the filtering component, so that the drug granules or multi-particulates cannot pass through.

The present embodiment has a wide application range, and is especially suitable for the situation that part of the particle sizes in particle size distribution of the drug granules or multi-particulates are smaller than or equal to the pore diameter of the pore channel.

The mechanism of the present embodiment is that, because the particle size distribution of drug granules or multi-particulates is in a range, it is impossible to eliminate all the granules or multi-particulates smaller than a certain size due to the limitation of the process. In the case, in order to ensure small resistance during sipping, a relatively large pore diameter will be selected when setting up the vertically and intricately crossed channel structure. Therefore, it is necessary to set a water-soluble material polymer layer on the filter membrane while setting the filtering component (such as the filter membrane) as the vertically and intricately crossed pore channel structure in order to meet the requirement of no leakage.

Next, a structure, a material, a pore diameter and setting conditions of a preparation process of the filtering component will be specifically described:

In the present invention, the filtering component is a conventional type in the art, and is preferably a filter membrane. The filter membrane is preferably a cylindrical structure. The thickness of the filter membrane is preferably 0.3-20 mm, more preferably 0.5-15 mm, and further more preferably 0.5-10 mm, such as 2 mm.

In other words, the filter membrane has a certain thickness, so setting of the pore channels of the filter membrane in the vertically and intricately crossed structure is preferably that upper and lower surfaces and the inner pore channels of the filter membrane are arranged in an irregular and intricately crossed structure, such as a spongy porous structure or a fluffy structure formed by irregularly stacking and pressing multiple layers of fibers.

The filter membrane is made of a conventional filter membrane material in the art, including but not limited to one or more of the following materials: polypropylene, polyethylene, polyvinyl chloride, polyvinylidene chloride, polyethylene terephthalate, cellulose acetate, polylactic acid, polyglycolic acid, polylactic acid-glycolic acid copolymer, glass fiber, nylon, polyether sulfone, polyvinylidene fluoride and polytetrafluoroethylene. The shape of the raw material of the filter membrane is conventional in the art, including but not limited to granular, flaky, fibrous, etc.

Wherein, the shape and structure of the pore channel in the filter membrane can be the conventional regular structure in the art, for example, connecting and penetrating the upper and lower surfaces of the filter membrane in a straight line way.

Wherein, the pore diameter of the filter membrane is conventional in the art, such as 1-500 μm, preferably 20-400 μm, more preferably 40-300 μm, such as 150 μm, 200 μm, 250 μm and 300 μm.

Wherein, the diameter of the filter membrane can be conventional in the art, and the diameter of the filter membrane is defined as the effective diameter for trapping solids and passing through liquids. In view of design and installation process, the outermost ring of the filter membrane diameter will be pressed between the upper and lower supporting components for fixing the filter membrane, for example, a membrane with a diameter of 10 mm, the edge of which is for 1 mm pressed by the supporting components, and the effective diameter is only 8 mm. Generally, the effective diameter range of the filter membrane is 4-20 mm, preferably 6-15 mm, more preferably 8 mm-12 mm, such as 10 mm.

Wherein, the preparation process of the filter membrane is a conventional process in the art, including but not limited to sintering, injection molding, pressing, weaving, etc.

Next, the arrangement mode of the water-soluble polymer material layer will be specifically described.

In the present invention, the forming method of the water-soluble polymer material layer is conventional in the art, and preferably: a polymer material solution is adsorbed, coated or sprayed on the upper surface and/or the lower surface of the filter membrane, or the filter membrane is immersed in the polymer material solution and dried. After drying, the polymer material is dispersed in pores and materials of the filter membrane to form a skeleton with a certain hardness, and meanwhile, the pore channels of the filter membrane are blocked, so that drug granules or multi-particulates smaller than or equal to the pore diameter of the filter membrane will not leak during storage and transportation.

Specifically, the water-soluble polymer material layer preferably has the following two structures: a continuous water-soluble polymer material layer is formed on the upper or lower surface of the filter membrane, or the polymer material will completely block the pore channels of the filter membrane and form a complete and compact water-soluble polymer material layer (for example, the structure is formed by dipping), and more preferably, a continuous water-soluble polymer material layer is formed only on the upper or lower surface of the filter membrane (for example, the structure is formed only by adsorption, coating or spraying on a certain surface of the filter membrane), and further more preferably, a continuous water-soluble polymer material layer is formed on the lower surface of the filter membrane.

Wherein, the dissolution time of the water-soluble polymer material layer is preferably less than or equal to 10 s, such as 2 s. In use, the patient places the drug accommodating apparatus in the liquid and then sips, and meanwhile, the water-soluble polymer material layer dissolves in a very short time, and the liquid passes through the drug accommodating apparatus with very little resistance to deliver the drug granules or multi-particulates into the patient's mouth. Because the water-soluble polymer material layer dissolves quickly, the patient can't feel the change of resistance in use.

Wherein, in order to make the polymer material solution better formed on the surface of the filter membrane, the polymer material solution with good water solubility and a good film forming property and a low molecular weight is preferably selected. The molecular weight of the polymer material is generally 2000-200000, preferably 2000-100000. Preferably, the types of the polymer material is selected from one or more of hydroxypropyl methylcellulose (HPMC), copolyvidone, hydroxypropyl cellulose (HPC), hydroxyethyl cellulose (HEC), povidone, polyethylene glycol (PEG), gelatin, poloxamer, xanthan gum and Eudragit.

Wherein, the preparation method of the polymer material solution is a conventional method in the art, and specifically comprises the following steps: uniformly mixing a polymer material and a solvent, wherein the solvent is a conventional solvent which can dissolve polymer materials and is volatile, such as water, ethanol, acetone, etc.

Wherein, in the forming process of the water-soluble polymer material layer, the viscosity of the polymer material solution is a key parameter in the forming process, and the viscosity depends on three parameters, namely the concentration, molecular weight and chemical structure of a polymer. The viscosity generally ranges from 2 centipoise (cP) to 5000 centipoise (cP), preferably 2 cP-1000 cP. The concentration of the polymer material solution is preferably 0.1%-30%, such as 10%, and the concentration is the mass percentage concentration. In the forming process of the water-soluble polymer material layer, the weight gain of the polymer material is generally 0.01-60 mg/cm², preferably 0.5-30 mg/cm², such as 6.4 mg/cm².

In a preferable embodiment of the present application, the polymer material solution is a hydroxypropyl methylcellulose E3 solution with a concentration of 10%.

Next, the structure of the supporting component will be specifically described.

In the present invention, the supporting component has a conventional meaning in the art, and a function thereof is to support the filtering component without affecting the filterability and liquid permeability of the filtering component.

In a preferable embodiment of the present application, the supporting component comprises an upper supporting component and a lower supporting component, which can be closed with each other and hold the filtering component in the middle, and the space above the upper supporting component and the filtering component is used for accommodating drug granules or multi-particulates. The structure is similar to the sandwich form.

In another preferable embodiment of the present application, the supporting component comprises a filter-component accommodating component and a drug accommodating component, both of which have a pore-like structure end and an open end, wherein the pore-like structure end has one or more holes allowing a liquid to pass through, and the open end of the filter-component accommodating component and the pore-like structure end of the drug accommodating component can be closed to form a cavity for accommodating the filtering component; and the open end of the drug accommodating component is an open tubular structure for accommodating drug granules or multi-particulates. It should be understood by those skilled in the art that the actual function of the filtering component accommodating component in the implementation is to form a cavity with the drug accommodating component for accommodating the filtering component, and the structure is similar to the sandwich form. In addition, sizes of the pore-like structures of the drug accommodating component and the filter-component accommodating component do not affect filterability and liquid permeability of the filtering component.

Wherein, the material of the supporting component is conventional in the art, including but not limited to one or more of the following materials: polypropylene, polyethylene, polyvinyl chloride, polyvinylidene chloride, polyvinylidene fluoride, polytetrafluoroethylene, polyethylene terephthalate, polylactic acid, polyglycolic acid, polylactic acid-glycolic acid copolymer, ceramics, silicon dioxide and organosilicone.

Wherein, the preparation process of the supporting component is conventional in the art, including but not limited to sintering, injection molding, etc.

Next, the forms and types of drug granules or multi-particulates will be specifically described:

In the present invention, the drug granules or multi-particulates have the conventional meaning in the art, and generally refer to granules, powders or multi-particulates containing active pharmaceutical ingredients.

Wherein, the particle sizes of the drug granules or multi-particulates are conventional in the art, and are generally 1-5000 μm, preferably 25-2000 μm, and more preferably 50-1000 μm.

Preferably, when the particle sizes of the drug granules or multi-particulates are in the range of 50-1000 μm, the pore diameter of the filtering component is 40-300 μm.

Wherein, the active pharmaceutical ingredients contained in the drug granules or multi-particulates are conventional in the art, including but not limited to one or more of dabigatran etexilate or pharmaceutically acceptable salts thereof (such as dabigatran etexilate mesylate), apixaban, rivaroxaban, levodopa-carbidopa, montelukast, lansoprazole, omeprazole, esomeprazole, amoxicillin, clarithromycin, azithromycin, metronidazole, rifampicin, sulfasalazine, acetaminophen, dextromethorphan, doxylamine, pseudo ephedrine, diphenhydramine, amphetamine, methylphenidate, deferasirox, ivacaftor, lumacaftor, tacrolimus, diazepam, clobazam, vigabatrin, bosentan, melatonin, biotin, sodium dimercaptosuccinate, amlodipine and esmolol.

Wherein, the preparation process of the drug granules or multi-particulates comprises but is not limited to one or more of the following processes: wet granulation, dry granulation, extrusion rolling, melt granulation, ion exchange resin granulation, and pellet spraying applying.

The eighth purpose of the present invention is to provide an oral delivery device, which comprises the drug accommodating apparatus described in the seventh purpose. The oral delivery device further comprises a tubular component with two end openings and an inner cavity, wherein one end opening is a first opening and the other end opening is a second opening, and the inner cavity is communicated with the first opening and the second opening; and the drug accommodating apparatus is externally connected to a free end of the first opening, and makes space for bearing drug granules or multi-particulates communicated with the inner cavity.

Next, the manner in which the drug accommodating apparatus is arranged outside the free end of the first opening will be specifically described:

In the present invention, the drug accommodating apparatus is placed outside the tubular component, and is preferably maintained at the first opening outside the tubular component by a fixed sleeve mode or threaded connection.

In the present embodiment, granules or multi-particulates containing active pharmaceutical ingredients are placed in the cavity of the drug accommodating apparatus. When in use, one end of the supporting component contacts with a liquid, and the liquid is sucked into the tubular component through the filtering component by sipping. The granules or multi-particulates containing the active pharmaceutical ingredients enter the tubular component with the liquid and then enter a mouth.

In the present invention, preferably, the second opening is also provided with a top cover for sealing, so as to ensure that even if the oral delivery device is bumped or completely inverted during transportation, the drug granules or multi-particulates will not leak from the second opening.

Next, the structure of the tubular component will be specifically described.

In a preferable embodiment of the present application, the tubular component is a straight straw. The straight straw is preferably provided with at least one fold structure. Preferably, the fold structure has a pair of wings and a turning end; and the fold structure can be stretched or contracted along the axial direction of the tubular component, and a turbulent flow is formed during stretching.

In another preferable embodiment of the present application, the tubular component has at least two tube sections which are hermetically connected and can be axially stretched or contracted along the tubular component; and when the tubular component is in a stretched state, a turbulent flow generating part with at least one step structure is formed.

When the number of the tube sections is 3, the inner diameters of the first tube section and the third tube section in the direction from the first opening to the second opening are the same, the outer diameter of the second tube section is smaller than the inner diameter of the first tube section, and each tube section can be axially stretched or contracted along other tube sections; or, the inner diameter of the first tube section, the outer diameter and the inner diameter of the second tube section, the outer diameter of the third tube section in the direction from the first opening to the second opening are gradually reduced, and each tube section can be axially stretched or contracted along other tube sections.

When the number of the tube sections is 4, the inner diameters of the first tube section and the third tube section in the direction from the first opening to the second opening are the same, and the inner diameters of the second tube section and the fourth tube section are the same, wherein the inner diameter of the second tube section is smaller than that of the first tube section, and each tube section can be axially stretched or contracted along other tube sections; or, the inner diameter thereof gradually decreases from the first tube section to the fourth tube section in the direction from the first opening to the second opening, and each tube section can be axially stretched or contracted along other tube sections.

The ninth purpose of the present invention is to provide an oral delivery device, which comprises the drug accommodating apparatus described in the seventh purpose. The oral delivery device further comprises a tubular component with two end openings and an inner cavity, wherein one end opening is a first opening and the other end opening is a second opening, and the inner cavity is communicated with the first opening and the second opening; the drug accommodating apparatus is arranged in the inner cavity and close to the first opening, and space for bearing drug granules or multi-particulates is communicated with the second opening; and the diameter of the first opening is smaller than the minimum diameter of the drug accommodating apparatus.

In the present invention, by limiting the diameter of the first opening to be smaller than the minimum diameter of the drug accommodating apparatus, the drug accommodating apparatus can be maintained in the inner cavity in any way without falling off from the first opening of the tubular component.

In the present invention, preferably, the diameter of the second opening is smaller than the minimum diameter of the drug accommodating apparatus.

In the present invention, preferably, the second opening is also provided with a top cover for sealing, so as to ensure that even if the oral delivery device is bumped or completely inverted during transportation, the drug granules or multi-particulates will not leak from the second opening.

In the present invention, the specific description of the structure of the tubular component is the same as that described in the eighth purpose.

Those skilled in the art should understand that the descriptions of “first opening”, “second opening”, “first tube section”, “second tube section”, “third tube section” and “fourth tube section” in the present invention are for convenience of explanation, and should not be understood as limiting specific positions or sequences.

On the basis of meeting the common sense in the art, the above-mentioned preferable conditions can be combined arbitrarily to obtain the preferable examples of the present invention. Reagents and raw materials used in the present invention are commercially available.

The positive progress effect of the present invention is that the drug accommodating apparatus of the present invention can better solve the problems of leakage of drug particles and large fluid resistance during sipping, and the oral delivery device formed by matching with the tubular component can be used as a packaging material directly contacting drugs, and has a storage function. When the oral delivery device of the present invention is in use, it is detected that when the length of the straw is 20 cm, the time for emptying the liquid filling the straw only under the action of gravity is less than 12 s.

### BRIEF DESCRIPTION OF THE DRAWINGS

FIG. 1 is a schematic structural diagram of supporting components and a filtering component of a drug accommodating apparatus of Embodiment 1, wherein 1a displays a lower supporting component, 1b displays a filtering component, and 1c displays an upper supporting component;

FIG. 2 is a schematic assembly diagram of supporting components and a filtering component of a drug accommodating apparatus of Embodiment 1, wherein 2a displays situations before assembly and 2b displays situations after assembly;

FIG. 3 is a schematic structural diagram of a built-in oral delivery device formed by assembling a drug accommodating apparatus and a straw of Embodiment 1;

FIG. 4 is a schematic structural diagram of supporting components and a filtering component of a drug accommodating apparatus according to Embodiment 2, wherein 4a displays a cage-like supporting component, 4b displays a filtering component, and 4c displays an upper cover of the cage-like supporting component;

FIG. 5 is a schematic assembly diagram of supporting components and a filtering component of a drug accommodating apparatus of Embodiment 2;

FIG. 6 is a schematic diagram of a built-in oral delivery device formed by assembling a drug accommodating apparatus and a straw of Embodiment 2;

FIG. 7 is a schematic diagram of a built-in oral delivery device of Embodiments 1-3 under use of a straw, wherein 7a displays situations before sipping and 7b displays situations after sipping;

FIG. 8 is a schematic structural diagram of a filter-component accommodating component, a filtering component and a drug accommodating component of a drug accommodating apparatus of Embodiment 4, wherein 8a displays a filter-component accommodating component, 8b displays a filtering component and 8c displays a drug accommodating component;

FIG. 9 is a schematic diagram of assembly of a filter-component accommodating component, a filtering component and a drug accommodating component of a drug accommodating apparatus of Embodiment 4, wherein 9a displays situations before assembly and 9b displays situations after assembly;

FIG. 10 is a schematic diagram of a built-out oral delivery device formed by assembling a drug accommodating apparatus and a straw of Embodiment 4;

FIG. 11 is a schematic diagram of a built-out oral delivery device of Embodiment 4 under use of a straw, wherein 11a displays situations before sipping and 11b displays situations after sipping;

FIG. 12 is a section view of an irregular and intricately crossed structure of an internal pore channel of a filtering component of an embodiment;

FIG. 13 is a schematic structural diagram of a drug accommodating apparatus of Embodiment 8; and

FIG. 14 is a schematic structural diagram of an oral delivery device of Embodiment 8.

### DETAILED DESCRIPTION OF THE PREFERABLE EMBODIMENT

### Embodiment 1 (Water-Soluble Polymer Material Layer+Built-In)

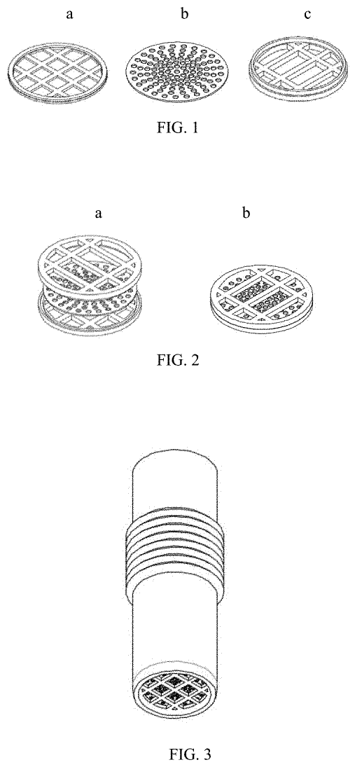

As shown in FIGS. 1-3, a filter membrane with a pore diameter of 150 μm and a thickness of 0.2 mm and made of polypropylene is cut into a wafer with a diameter of 1 cm. The filter membrane is soaked in a 10% hydroxypropyl methylcellulose E3 solution, and then dried in an oven. After drying (weight gain is 6.4 mg/cm²), the filter membrane is placed between two polyethylene wafers with a diameter of 1 cm and a thickness of 3 mm, and the two polyethylene wafers are covered with grids with a diameter of 2 mm×2 mm which is vertically through. The surface of one polyethylene wafer is provided with four protrusions with a diameter of 2 mm, and the symmetrical position of the surface of the other polyethylene wafer is provided with four pits with a diameter of 2 mm. The two wafers are mechanically condensed by a concave-convex structure, and the filter membrane is tightly fixed in the middle to form a drug accommodating apparatus. The device is placed in a fold straw with an inner diameter of 1.05 cm from a nozzle at one end contacting with a liquid, and the drug accommodating apparatus can stay in the straw by bending the nozzle inward.

### Embodiment 2 (Intricately Crossed Pore Channel Structure+Built-In)

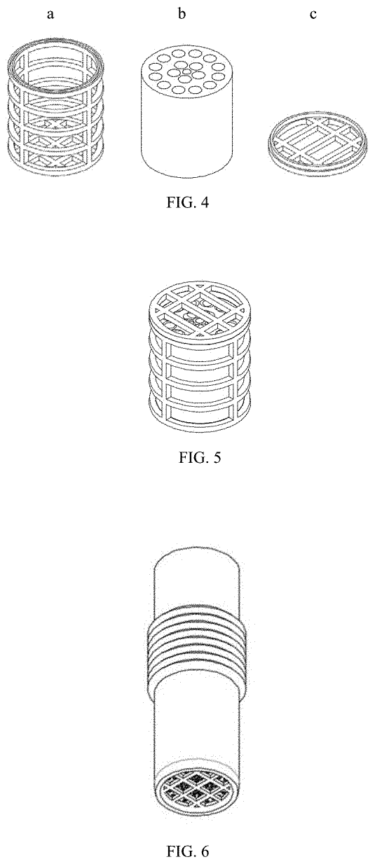

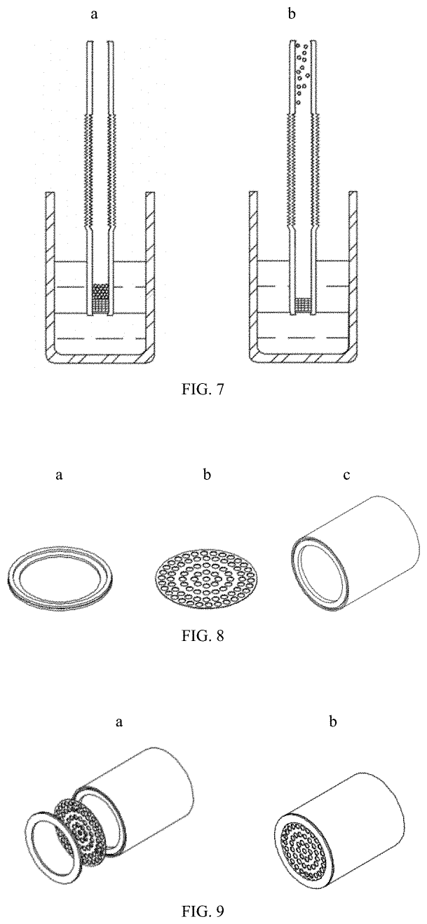

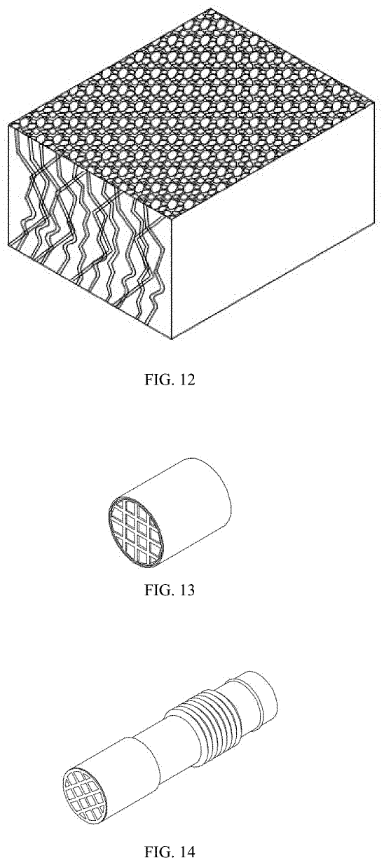

As shown in FIGS. 4-6, a filter membrane made of polypropylene with a pore diameter of 300 μm and a thickness of 6 mm (the filter membrane is provided with intricately crossed irregular pore channels) (FIG. 12 is a schematic diagram of the internal pore channel structure of the filtering component in FIG. 4 and FIG. 8) is cut into a cylinder with a diameter of 8 mm. The cylindrical filter membrane is placed in a cylindrical filter membrane accommodating device with an inner cavity diameter of 8.1 mm and a height of 6 mm; the bottom and a cover of the cylinder are covered with 2 mm×2 mm grids which are vertically through; and the cylinder cover is fixed with a cylinder body by mechanical condensation, and the filter membrane is wrapped in the cylinder cover to form a drug accommodating apparatus. The device is placed in a fold straw with an inner diameter of 1.2 cm from a nozzle at the end contacting with the liquid, and the nozzle is bent inward, so that the drug accommodating apparatus can stay in the straw.

### Embodiment 3 (Intricately Crossed Pore Channel Structure+Water Soluble Polymer Material Layer+Built-In)

As shown in FIGS. 1-3, a filter membrane with a pore diameter of 300 μm and a thickness of 1.5 mm and made of polypropylene (the filter membrane is provided with intricately crossed irregular pore channels) is cut into a wafer with a diameter of 1 cm. The filter membrane is soaked in a 10% hydroxypropyl methylcellulose E3 solution, and then dried in an oven. After drying (weight gain is 25.5 mg/cm²), the filter membrane is placed between two polyethylene wafers with a diameter of 1 cm and a thickness of 3 mm, and the two polyethylene wafers are covered with grids with a diameter of 2 mm×2 mm which is vertically through. The surface of one polyethylene wafer is provided with four protrusions with a diameter of 2 mm, and the symmetrical position of the surface of the other polyethylene wafer is provided with four pits with a diameter of 2 mm. The two wafers are mechanically condensed by a concave-convex structure, and the filter membrane is tightly fixed in the middle to form a drug accommodating apparatus. The device is placed in a fold straw with an inner diameter of 1.05 cm from a nozzle at one end contacting with a liquid, and the drug accommodating apparatus can stay in the straw by bending the nozzle inward.

The schematic structural diagrams of the devices of Embodiments 1, 2 and 3 in use are shown in FIG. 7.

### Embodiment 4 (Intricately Crossed Pore Channel Structure+Built-Out)

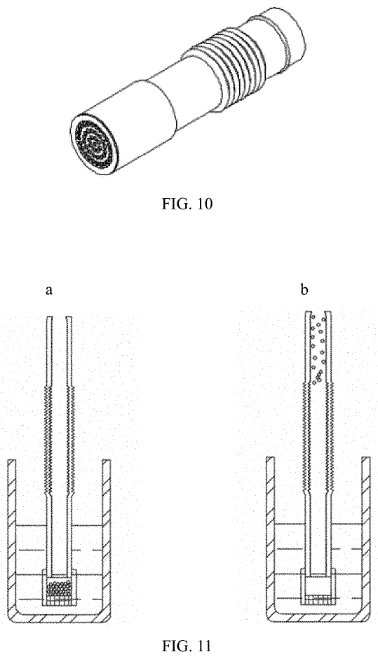

As shown in FIGS. 8-11, a filter membrane with a pore diameter of 100 μm and a thickness of 2 mm and made of polypropylene (the filter membrane is provided with intricately crossed irregular pore channels) is cut into a wafer with a diameter of 12 mm. By an injection molding process, an accommodating component of a filtering component and a drug accommodating component are prepared. The filter-component accommodating component is a cylindrical structure with an inner diameter of 12.1 mm and an inner height of 4 mm, and the bottom of the cylinder is provided with a round hole with a diameter of 8 mm, which is vertically through; and the drug accommodating component has a cylindrical structure with an inner diameter of 9.1 mm and an inner height of 1.5 cm. The filter membrane is placed in the cylindrical structure of the filter-component accommodating component, and then the lower end of the drug accommodating component is pressed thereon, and both are condensed by a mechanical structure to fix the filter membrane in the middle, thus obtaining a drug accommodating apparatus. Then, the upper end of the drug accommodating apparatus is connected with a nozzle at an end, contacting a liquid, of a fold straw (inner diameter 8.6 mm). 504.1 mg of hot-melt granulated dabigatran etexilate mesylate particles (containing 75 mg dabigatran etexilate, particle size distribution as shown in Table 1) are filled into the drug accommodating apparatus through the upper end of the straw, and no particles leak through the drug accommodating apparatus. In use, one end of the straw with the drug accommodating apparatus is placed in the liquid, a patient sucks the liquid into the straw by sipping, and the liquid easily passes through the drug accommodating apparatus and pushes the dabigatran etexilate mesylate particles into the patient's mouth, thus completing drug administration.

TABLE 1
Particle size distribution of hot-melt granulated
dabigatran etexilate mesylate particles

| | |
|---|---|
| Particle size range | Percentage |

| | | |
|---|---|---|
| >355 | μm | 23.8% |
| 250-355 | μm | 7.6% |
| 180-250 | μm | 35.9% |
| 180 | μm | 32.7% |

### Embodiment 5 (Intricately Crossed Pore Channel Structure+Water-Soluble Polymer Material Layer+Built-Out)

As shown in FIGS. 8-11, a filter membrane with a pore diameter of 300 μm and a thickness of 1.5 mm and made of polypropylene is provided with intricately crossed irregular channels, and is cut into a wafer with a diameter of 12 mm. The filter membrane is soaked in 10% Killidon VA64 ethanol solution, and then dried in an oven, and the weight gain after drying is 16.0 mg/cm². By an injection molding process, an accommodating component of a filtering component and a drug accommodating component are prepared. The filter-component accommodating component is a cylindrical structure with an inner diameter of 12.1 mm and an inner height of 4 mm, and the bottom of the cylinder is provided with a round hole with a diameter of 8 mm, which is vertically through; and the drug accommodating component has a cylindrical structure with an inner diameter of 9.1 mm and an inner height of 1.5 cm. The filter membrane is placed in the cylindrical structure of the filter-component accommodating component, and then the lower end of the drug accommodating component is pressed thereon, and both are condensed by a mechanical structure to fix the filter membrane in the middle, thus obtaining a drug accommodating apparatus. Then, the upper end of the drug accommodating apparatus is connected with a nozzle at an end, contacting a liquid, of a fold straw (inner diameter 8.6 mm). 500 mg of D-mannitol pellets with a particle size ranging from 75 μm to 150 μm are filled into the cylinder of the drug accommodating apparatus through the upper end of the straw, and no multiple pills leak through the drug accommodating apparatus.

### Embodiment 6 (Water-Soluble Polymer Material Layer+Built-Out)

As shown in FIGS. 8-11, a filter membrane with a pore diameter of 250 μm and a thickness of 0.3 mm and made of polypropylene is cut into a wafer with a diameter of 12 mm. The filter membrane is soaked in 10% Killidon VA64 ethanol solution, and then dried in an oven, and the weight gain after drying is 8.9 mg/cm². By an injection molding process, an accommodating component of a filtering component and a drug accommodating component are prepared. The filter-component accommodating component is a cylindrical structure with an inner diameter of 12.1 mm and an inner height of 3 mm, and the bottom of the cylinder is provided with a round hole with a diameter of 8 mm, which is vertically through; and the drug accommodating component has a cylindrical structure with an inner diameter of 9.1 mm and an inner height of 1.5 cm. The filter membrane is placed in the cylindrical structure of the filter-component accommodating component, and then the lower end of the drug accommodating component is pressed thereon, and both are condensed by a mechanical structure to fix the filter membrane in the middle, thus obtaining a drug accommodating apparatus. Then, the upper end of the drug accommodating apparatus is connected with a nozzle at an end, contacting a liquid, of a fold suction tube (inner diameter 8.6 mm).

### Embodiment 7 (Intricately Crossed Pore Channel Structure+Built-Out)

The drug accommodating apparatus in Embodiment 4 is assembled with a straw with a total length of 20 cm, an inner diameter of 8.6 mm and a fold length of 4 cm. The lower end of the drug accommodating apparatus is blocked with fingers, and the straw is filled with a liquid from the upper end. Under the action of gravity, the liquid in the device is emptied for about 2-3 s.

### Embodiment 8 (Water-Soluble Polymer Material Layer+Built-Out)

As shown in FIGS. 13-14, a drug accommodating apparatus is prepared by an injection molding process. The drug accommodating apparatus has a cylindrical structure with an inner diameter of 9 mm, a height of 2 cm and a wall thickness of 1 mm; the inner diameter of the cylinder bottom is 9 mm, with a plurality of screen meshs with a pore diameter of 200 μm, which are vertically through; and the inner wall of a cylinder mouth is designed with two rings of raised annular structures, which are used to connect a straw in an external way. A 7.5% HPMC E3 aqueous solution is coated on the inner surface of the cylinder bottom and dried, and the weight gain is 17.7 mg/cm², so that the drug accommodating apparatus is obtained.

### Embodiment 9 (Intricately Crossed Pore Channel Structure+Built-Out)

As shown in FIGS. 8-11, a filter membrane with a pore diameter of 100 μm and a thickness of 2 mm and made of polypropylene (the filter membrane is provided with intricately crossed irregular pore channels) is cut into a wafer with a diameter of 16 mm. By an injection molding process, an accommodating component of a filtering component and a drug accommodating component are prepared. The filter-component accommodating component is a cylindrical structure with an inner diameter of 16.1 mm and an inner height of 4 mm, and the bottom of the cylinder is provided with a round hole with a diameter of 12 mm, which is vertically through; and the drug accommodating component has a cylindrical structure with an inner diameter of 12.5 mm and an inner height of 1.5 cm. The filter membrane is placed in the cylindrical structure of the filter-component accommodating component, and then the lower end of the drug accommodating component is pressed thereon, and both are condensed by a mechanical structure to fix the filter membrane in the middle, thus obtaining a drug accommodating apparatus. Then, the upper end of the drug accommodating apparatus is connected with a nozzle at an end, contacting a liquid, of a fold suction tube (inner diameter 12 mm). 320 mg of omeprazole enteric-coated multi-particulates (including 20 mg of omeprazole), 1334 mg of amoxicillin granules (including 1000 mg of amoxicillin) and 840 mg of clarithromycin granules (including 500 mg of clarithromycin) are filled into the drug accommodating device through the upper end of the straw, and no multi-particulates or granules leak through the drug accommodating apparatus. In use, one end of the straw with the drug accommodating apparatus is placed in a liquid, and a patient sucks the liquid into the straw by sipping, and the liquid easily passes through the drug accommodating apparatus and pushes the pills particles into the patient's mouth, thus completing drug administration. The particle size range of omeprazole enteric-coated multiple pills is 0.25-0.355 mm. See Table 2 and Table 3 for the particle size distribution of amoxicillin particles and clarithromycin particles.

TABLE 2
Particle size distribution of amoxicillin particles

| | |
|---|---|
| Particle size range | Percentage |

| | | |
|---|---|---|
| 425-600 | μm | 22.8% |
| 250-425 | μm | 33.6% |
| 150-250 | μm | 25.7% |
| <150 | μm | 17.9% |

TABLE 3
Particle size distribution of clarithromycin.

| | |
|---|---|
| Particle size range | Percentage |

| | | |
|---|---|---|
| 425-600 | μm | 32.1% |
| 250-425 | μm | 16.7% |
| 150-250 | μm | 28.9% |
| <150 | μm | 2.3% |

### Embodiment 10 (Intricately Crossed Pore Channel Structure+Built-In)

The structure and other parameters of the present embodiment are the same as those of Embodiment 2, and leakage prevention effects realized are the same. The only difference is that the filter membrane in Embodiment 2 is replaced by a sponge-like porous structure, so that the present embodiment has an irregular and intricately crossed structure.

### Embodiment 11 (Intricately Crossed Pore Channel Structure+Built-Out)

The structure and other parameters of the present embodiment are the same as those of Embodiment 4, and leakage prevention effects realized are the same. The only difference is that the filter membrane in Embodiment 4 is replaced by a fluffy structure formed by irregular stacking and pressing multiple layers of fibers, so that the present embodiment has an irregular and intricately crossed structure.

Although specific implementations of the present invention have been described above, it should be understood by those skilled in the art that these are only examples, and various changes or modifications can be made to the embodiments without departing from the principles and essence of the present invention. Therefore, the scope of protection of the present invention is defined by the attached claims.

What is claimed is:

1. A drug accommodating apparatus of a solid oral preparation, which comprises a filtering component and a supporting component for supporting the filtering component, wherein the filtering component and the supporting components cooperate with each other to form space for bearing drug granules or multi-particulates, and the filtering component has one or more pore channels allowing a liquid to pass; and when the thickness of the filtering component is more than 0.5 mm, the pore channels are distributed in the filtering component in an up-down intricate intersection mode, so that the drug granules or multi-particulates cannot pass through.

2. The drug accommodating apparatus according to claim 1, wherein the filtering component is a filter membrane;
the shape of the filter membrane is preferably a cylindrical structure;
the thickness of the filter membrane is preferably 0.5-20 mm, more preferably 0.5-15 mm, and further more preferably 0.5-10 mm;
preferably, upper and lower surfaces and the inner pore channels of the filter membrane are arranged in an irregular and intricately crossed structure, more preferably a spongy porous structure or a fluffy structure formed by irregularly stacking and pressing multiple layers of fibers;
the pore diameter of the filter membrane is preferably 1-500 μm, more preferably 20-400 μm and further more preferably 40-300 μm;
the effective diameter of the filter membrane is 4-20 mm, preferably 6-15 mm, and further more preferably 8 mm-12 mm;
and/or,
the particle sizes of the drug granules or multi-particulates are 1-5000 μm, preferably 25-2000 μm, and more preferably 50-1000 μm;
preferably, when the particle sizes of the drug granules or multi-particulates are in the range of 50-1000 μm, the pore diameter of the filtering component is 40-300 μm;
and/or,
the active pharmaceutical ingredients contained in the drug granules or multi-particulates comprise but not limited to one or more of dabigatran etexilate or pharmaceutically acceptable salts thereof, apixaban, rivaroxaban, levodopa-carbidopa, montelukast, lansoprazole, omeprazole, esomeprazole, amoxicillin, clarithromycin, azithromycin, metronidazole, rifampicin, sulfasalazine, acetaminophen, dextromethorphan, doxylamine, pseudo ephedrine, diphenhydramine, amphetamine, methylphenidate, deferasirox, ivacaftor, lumacaftor, tacrolimus, diazepam, clobazam, vigabatrin, bosentan, melatonin, biotin, sodium dimercaptosuccinate, amlodipine and esmolol.

3. The drug accommodating apparatus according to claim 1, wherein the structure of the supporting component is as follows: the supporting component is arranged on upper and lower surfaces of the filtering component and clamps the filtering component in the middle, or the filtering component is wrapped inside in a cage structure;
preferably, the structure of the supporting component is any one of the following structures:
the supporting component comprises an upper supporting component and a lower supporting component, which can be closed with each other and hold the filtering component in the middle, and the space above the upper supporting component and the filtering component is used for accommodating drug granules or multi-particulates;
or the supporting component comprises a filter-component accommodating component and a drug accommodating component, both of which have a pore-like structure end and an open end, wherein the pore-like structure end has one or more holes allowing a liquid to pass through, and the open end of the filter-component accommodating component and the pore-like structure end of the drug accommodating component can be closed to form a cavity for accommodating the filtering component; and the open end of the drug accommodating component is an open tubular structure for accommodating drug granules or multi-particulates;
or the supporting component comprises a cage-like supporting component with an upward opening and an upper cover matched with the cage-like supporting component, wherein the upper cover is provided with a pore channel for drug granules or multi-particulates and a liquid to circulate, and the cage-like supporting component and the upper cover can enclose to form hollow space and limit the filtering component in the space, and the space above the upper cover and the filtering component is used for accommodating the drug granules or multi-particulates.

4. An oral delivery device (i) or (ii), which comprises the drug accommodating apparatus according to claim 1,
the oral delivery device (i) further comprises a tubular component with two end openings and an inner cavity, wherein one end opening is a first opening and the other end opening is a second opening, and the inner cavity is communicated with the first opening and the second opening; and the drug accommodating apparatus is externally connected to a free end of the first opening, and makes space for bearing drug granules or multi-particulates communicated with the inner cavity;
the oral delivery device (ii) further comprises a tubular component with two end openings and an inner cavity, wherein one end opening is a first opening and the other end opening is a second opening, and the inner cavity is communicated with the first opening and the second opening; the drug accommodating apparatus is arranged in the inner cavity and close to the first opening, and space for bearing drug granules or multi-particulates is communicated with the second opening; and the diameter of the first opening is smaller than the minimum diameter of the drug accommodating apparatus.

5. The oral delivery device according to claim 4, wherein the drug accommodating apparatus of the oral delivery device (i) is placed outside the tubular component, and is maintained at the first opening of the tubular component by a fixed sleeve or threaded connection;
and/or, the diameter of the second opening is smaller than the minimum diameter of the drug accommodating apparatus of the oral delivery device (ii);
and/or, the second opening is also provided with a top cover for sealing;
and/or, the tubular component is a straight straw; the straight straw is preferably provided with at least one fold structure; preferably, the fold structure has a pair of wings and a turning end; and the fold structure can be stretched or contracted along the axial direction of the tubular component, and a turbulent flow is formed during stretching;
and/or, the tubular component has at least two tube sections which are hermetically connected and can be axially stretched or contracted along the tubular component; and when the tubular component is in a stretched state, a turbulent flow generating part with at least one step structure is formed,
wherein, when the number of the tube sections is 3, the inner diameters of the first tube section and the third tube section in the direction from the first opening to the second opening are the same, the outer diameter of the second tube section is smaller than the inner diameter of the first tube section, and each tube section can be axially stretched or contracted along other tube sections; or, the inner diameter of the first tube section, the outer diameter and the inner diameter of the second tube section, the outer diameter of the third tube section in the direction from the first opening to the second opening are gradually reduced, and each tube section can be axially stretched or contracted along other tube sections;
wherein, when the number of the tube sections is 4, the inner diameters of the first tube section and the third tube section in the direction from the first opening to the second opening are the same, and the inner diameters of the second tube section and the fourth tube section are the same, wherein the inner diameter of the second tube section is smaller than that of the first tube section, and each tube section can be axially stretched or contracted along other tube sections; or, the inner diameter thereof gradually decreases from the first tube section to the fourth tube section in the direction from the first opening to the second opening, and each tube section can be axially stretched or contracted along other tube sections.

6. (canceled)

7. (canceled)

8. A drug accommodating apparatus of a solid oral preparation, characterized by having a structure 1 or a structure 2:
structure 1: the drug accommodating apparatus comprises a filtering component and a supporting component for supporting the filtering component, wherein the filtering component and the supporting components cooperate with each other to form space for bearing drug granules or multi-particulates, and the filtering component has one or more pore channels allowing a liquid to pass; and the filtering component is also provided with a water-soluble polymer material layer, so that the drug granules or multi-particulates cannot pass through; and
structure 2: the drug accommodating apparatus is a cylindrical structure with a top end being an opening and a bottom part being a screen mesh, and the inner surface of the screen mesh is provided with a water-soluble polymer material layer, and the inner cavity having the cylindrical structure above the water-soluble polymer material layer is used for accommodating drug granules or multi-particulates.

9. The drug accommodating apparatus according to claim 8, wherein the filtering component is a filter membrane;
the shape of the filter membrane is preferably a wafer structure;
the thickness of the filter membrane is preferably 0.01-0.5 mm, more preferably 0.1-0.3 mm;
preferably, the pore channel in the filter membrane connects and penetrates the upper and lower surfaces of the filter membrane in a straight line way;
the pore diameter of the filter membrane is preferably 1-500 μm, more preferably 20-400 μm, and further more preferably 40-300 μm;
the effective diameter of the filter membrane is preferably 4-20 mm, more preferably 6-15 mm, and further more preferably 8 mm-12 mm;
and/or,
the particle sizes of the drug granules or multi-particulates are 1-5000 μm, preferably 25-2000 μm, and more preferably 50-1000 μm;
preferably, when the particle sizes of the drug granules or multi-particulates are in the range of 50-1000 μm, the pore diameter of the filtering component in the structure 1 or the screen mesh in the structure 2 is 40-300 μm;
and/or,
the active pharmaceutical ingredients contained in the drug granules or multi-particulates comprise but not limited to one or more of dabigatran etexilate or pharmaceutically acceptable salts thereof, apixaban, rivaroxaban, levodopa-carbidopa, montelukast, lansoprazole, omeprazole, esomeprazole, amoxicillin, clarithromycin, azithromycin, metronidazole, rifampicin, sulfasalazine, acetaminophen, dextromethorphan, doxylamine, pseudo ephedrine, diphenhydramine, amphetamine, methylphenidate, deferasirox, ivacaftor, lumacaftor, tacrolimus, diazepam, clobazam, vigabatrin, bosentan, melatonin, biotin, sodium dimercaptosuccinate, amlodipine and esmolol.

10. The drug accommodating apparatus according to claim 8, wherein the water-soluble polymer material layer has the following two structures: a continuous water-soluble polymer material layer is formed on the upper or lower surface of the filter membrane, or the polymer material completely blocks the pore channels of the filter membrane and forms a complete and compact water-soluble polymer material layer;
and/or, the dissolution time of the water-soluble polymer material layer is less than or equal to 10 s;
and/or, the molecular weight of the polymer material in the water-soluble polymer material layer is 2000-200000, preferably 2000-100000;
and/or, the type of the polymer material in the water-soluble polymer material layer is selected from one or more of hydroxypropyl methylcellulose, copolyvidone, hydroxypropyl cellulose, hydroxyethyl cellulose (HEC), povidone, polyethylene glycol (PEG), gelatin, poloxamer, xanthan gum and Eudragit;
and/or, in the forming process of the water-soluble polymer material layer, the weight gain of the polymer material is 0.01-60 mg/cm², preferably 0.5-30 mg/cm².

11. The drug accommodating apparatus according to claim 8, wherein the structure of the supporting component is any one of the following structures:
the supporting component comprises an upper supporting component and a lower supporting component, which can be closed with each other and hold the filtering component in the middle, and the space above the upper supporting component and the filtering component is used for accommodating drug granules or multi-particulates;
or the supporting component comprises a filter-component accommodating component and a drug accommodating component, both of which have a pore-like structure end and an open end, wherein the pore-like structure end has one or more holes allowing a liquid to pass through, and the open end of the filter-component accommodating component and the pore-like structure end of the drug accommodating component can be closed to form a cavity for accommodating the filtering component; and the open end of the drug accommodating component is an open tubular structure for accommodating drug granules or multi-particulates.

12. An oral delivery device (iii) or (iv), which comprises the drug accommodating apparatus according to claim 8,
the oral delivery device (iii) further comprises a tubular component with two end openings and an inner cavity, wherein one end opening is a first opening and the other end opening is a second opening, and the inner cavity is communicated with the first opening and the second opening; and the drug accommodating apparatus is externally connected to a free end of the first opening, and makes space for bearing drug granules or multi-particulates communicated with the inner cavity;
the oral delivery device (iv) further comprises a tubular component with two end openings and an inner cavity, wherein one end opening is a first opening and the other end opening is a second opening, and the inner cavity is communicated with the first opening and the second opening; the drug accommodating apparatus is arranged in the inner cavity and close to the first opening, and space for bearing drug granules or multi-particulates is communicated with the second opening; and the diameter of the first opening is smaller than the minimum diameter of the drug accommodating apparatus.

13. The oral delivery device according to claim 12, wherein the drug accommodating apparatus of the oral delivery device (iii) is placed outside the tubular component, and is maintained at the first opening of the tubular component by a fixed sleeve or threaded connection;
and/or, the diameter of the second opening is smaller than the minimum diameter of the drug accommodating apparatus of the oral delivery device (iv);
and/or, the second opening is also provided with a top cover for sealing;
and/or, the tubular component is a straight straw; the straight straw is preferably provided with at least one fold structure; preferably, the fold structure has a pair of wings and a turning end; and the fold structure can be stretched or contracted along the axial direction of the tubular component, and a turbulent flow is formed during stretching;
and/or, the tubular component has at least two tube sections which are hermetically connected and can be axially stretched or contracted along the tubular component; and when the tubular component is in a stretched state, a turbulent flow generating part with at least one step structure is formed,
wherein, when the number of the tube sections is 3, the inner diameters of the first tube section and the third tube section in the direction from the first opening to the second opening are the same, the outer diameter of the second tube section is smaller than the inner diameter of the first tube section, and each tube section can be axially stretched or contracted along other tube sections; or, the inner diameter of the first tube section, the outer diameter and the inner diameter of the second tube section, the outer diameter of the third tube section in the direction from the first opening to the second opening are gradually reduced, and each tube section can be axially stretched or contracted along other tube sections;
wherein, when the number of the tube sections is 4, the inner diameters of the first tube section and the third tube section in the direction from the first opening to the second opening are the same, and the inner diameters of the second tube section and the fourth tube section are the same, wherein the inner diameter of the second tube section is smaller than that of the first tube section, and each tube section can be axially stretched or contracted along other tube sections; or, the inner diameter thereof gradually decreases from the first tube section to the fourth tube section in the direction from the first opening to the second opening, and each tube section can be axially stretched or contracted along other tube sections.

14. (canceled)

15. (canceled)

16. A drug accommodating apparatus of a solid oral preparation, which comprises a filtering component and a supporting component for supporting the filtering component, wherein the filtering component and the supporting components cooperate with each other to form space for bearing drug granules or multi-particulates, and the filtering component has one or more pore channels allowing a liquid to pass; and the pore channels are distributed in the filtering component in an up-down intricate intersection mode, and a water-soluble polymer material layer is also arranged on the filtering component, so that the drug granules or multi-particulates cannot pass through.

17. The drug accommodating apparatus according to claim 16, wherein the filtering component is a filter membrane;
the shape of the filter membrane is preferably a cylindrical structure;
the thickness of the filter membrane is preferably 0.3-20 mm, more preferably 0.5-15 mm, and further more preferably 0.5-10 mm;
preferably, upper and lower surfaces and the inner pore channels of the filter membrane are arranged in an irregular and intricately crossed structure, more preferably a spongy porous structure or a fluffy structure formed by irregularly stacking and pressing multiple layers of fibers;
the pore diameter of the filter membrane is preferably 1-500 μm, more preferably 20-400 μm and further more preferably 40-300 μm;
the effective diameter of the filter membrane is 4-20 mm, preferably 6-15 mm, and further more preferably 8 mm-12 mm;
and/or
particle sizes of the drug granules or multi-particulates are 1-5000 μm, preferably 25-2000 μm, and more preferably 50-1000 μm;
preferably, when the particle sizes of the drug granules or multi-particulates are in the range of 50-1000 μm, the pore diameter of the filtering component is 40-300 μm;
and/or
the active pharmaceutical ingredients contained in the drug granules or multi-particulates comprise but not limited to one or more of dabigatran etexilate or pharmaceutically acceptable salts thereof, apixaban, rivaroxaban, levodopa-carbidopa, montelukast, lansoprazole, omeprazole, esomeprazole, amoxicillin, clarithromycin, azithromycin, metronidazole, rifampicin, sulfasalazine, acetaminophen, dextromethorphan, doxylamine, pseudo ephedrine, diphenhydramine, amphetamine, methylphenidate, deferasirox, ivacaftor, lumacaftor, tacrolimus, diazepam, clobazam, vigabatrin, bosentan, melatonin, biotin, sodium dimercaptosuccinate, amlodipine and esmolol.

18. The drug accommodating apparatus according to claim 16, wherein the water-soluble polymer material layer has the following two structures: a continuous water-soluble polymer material layer is formed on the upper or lower surface of the filter membrane, or the polymer material completely blocks the pore channels of the filter membrane and forms a complete and compact water-soluble polymer material layer;
and/or, the dissolution time of the water-soluble polymer material layer is less than or equal to 10 s;
and/or, the molecular weight of the polymer material in the water-soluble polymer material layer is 2000-200000, preferably 2000-100000;
and/or, the type of the polymer material in the water-soluble polymer material layer is selected from one or more of hydroxypropyl methylcellulose, copolyvidone, hydroxypropyl cellulose, hydroxyethyl cellulose (HEC), povidone, polyethylene glycol (PEG), gelatin, poloxamer, xanthan gum and Eudragit;
and/or, in the forming process of the water-soluble polymer material layer, the weight gain of the polymer material is 0.01-60 mg/cm², preferably 0.5-30 mg/cm².

19. The drug accommodating apparatus according to claim 16, wherein the structure of the supporting component is any one of the following structures:
the supporting component comprises an upper supporting component and a lower supporting component, which can be closed with each other and hold the filtering component in the middle, and the space above the upper supporting component and the filtering component is used for accommodating drug granules or multi-particulates;
or the supporting component comprises a filter-component accommodating component and a drug accommodating component, both of which have a pore-like structure end and an open end, wherein the pore-like structure end has one or more holes allowing a liquid to pass through, and the open end of the filter-component accommodating component and the pore-like structure end of the drug accommodating component can be closed to form a cavity for accommodating the filtering component; and the open end of the drug accommodating component is an open tubular structure for accommodating drug granules or multi-particulates.

20. An oral delivery device (v) or (vi) which comprises the drug accommodating apparatus according to claim 16,
the oral delivery device (v) further comprises a tubular component with two end openings and an inner cavity, wherein one end opening is a first opening and the other end opening is a second opening, and the inner cavity is communicated with the first opening and the second opening; and the drug accommodating apparatus is externally connected to a free end of the first opening, and makes space for bearing drug granules or multi-particulates communicated with the inner cavity;
the oral delivery device (vi) further comprises a tubular component with two end openings and an inner cavity, wherein one end opening is a first opening and the other end opening is a second opening, and the inner cavity is communicated with the first opening and the second opening; the drug accommodating apparatus is arranged in the inner cavity and close to the first opening, and space for bearing drug granules or multi-particulates is communicated with the second opening; and the diameter of the first opening is smaller than the minimum diameter of the drug accommodating apparatus.

21. The oral delivery device according to claim 20, wherein the drug accommodating apparatus of the oral delivery device (v) is placed outside the tubular component, and is maintained at the first opening of the tubular component by a fixed sleeve or threaded connection;
and/or, the diameter of the second opening is smaller than the minimum diameter of the drug accommodating apparatus of the oral delivery device (vi);
and/or, the second opening is also provided with a top cover for sealing;
and/or, the tubular component is a straight straw; the straight straw is preferably provided with at least one fold structure; preferably, the fold structure has a pair of wings and a turning end; and the fold structure can be stretched or contracted along the axial direction of the tubular component, and a turbulent flow is formed during stretching;
and/or, the tubular component has at least two tube sections which are hermetically connected and can be axially stretched or contracted along the tubular component; and when the tubular component is in a stretched state, a turbulent flow generating part with at least one step structure is formed,
wherein, when the number of the tube sections is 3, the inner diameters of the first tube section and the third tube section in the direction from the first opening to the second opening are the same, the outer diameter of the second tube section is smaller than the inner diameter of the first tube section, and each tube section can be axially stretched or contracted along other tube sections; or, the inner diameter of the first tube section, the outer diameter and the inner diameter of the second tube section, the outer diameter of the third tube section in the direction from the first opening to the second opening are gradually reduced, and each tube section can be axially stretched or contracted along other tube sections;
wherein, when the number of the tube sections is 4, the inner diameters of the first tube section and the third tube section in the direction from the first opening to the second opening are the same, and the inner diameters of the second tube section and the fourth tube section are the same, wherein the inner diameter of the second tube section is smaller than that of the first tube section, and each tube section can be axially stretched or contracted along other tube sections; or, the inner diameter thereof gradually decreases from the first tube section to the fourth tube section in the direction from the first opening to the second opening, and each tube section can be axially stretched or contracted along other tube sections.

22. (canceled)

23. (canceled)
